(19) United States
(12) Patent Application Publication
(10) Pub. No.: US 2006/0152173 A1
(43) Pub. Date: Jul. 13, 2006

(54) Method and apparatus for intentionally damaging a solid-state disk

(75) Inventor: Eran Erez, Gedera (IL)

Correspondence Address: DR. MARK FRIEDMAN LTD.;C/o Bill Polkinghorn, 9003 Florin Way, Upper Marlboro, MD, 20772, US

(73) Assignee: M-SYSTEMS FLASH DISK PIONEERS LTD.

(21) Appl. No.: 11/113,153

(22) Filed: Apr. 25, 2005

Related U.S. Application Data
(60) Provisional application No. 60/639,445, filed on Dec. 27, 2004.

(51) Int. Cl. H05B 41/36

(52) U.S. Cl. 315/307

(57) ABSTRACT

A device and method for disabling one or more memory components of a solid state memory device such as a NAND flash memory device is provided. In some embodiments, the presently disclosed memory device includes a damaging mechanism operative to physically damage a memory component. In a particular embodiment, the memory component to be damaged includes at least one pin, and the damaging mechanism is operative to apply a voltage to at least one pin sufficient to damage one or more memory components. In some embodiments, the damaging mechanism is activated in accordance with one or more specific software commands and/or hardware signals. Optionally, the presently disclosed device includes a prioritizing mechanism for prioritizing an order in which specific memory components are damaged by the damaging mechanism.

### CROSS-REFERENCE TO RELATED APPLICATIONS

This patent application claims the benefit of U.S. Provisional Patent Application No. 60/639,445, filed Dec. 27, 2004 by the present inventor.

### FIELD OF THE INVENTION

The present invention relates to data security, and in particular to storage devices including a damaging mechanism for damaging one or more memory components of the storage device.

### BACKGROUND OF THE INVENTION

For as long as data has been stored digitally, there has been an ongoing need to remove sensitive data from the magnetic or solid state medium in which they are stored in a manner that renders the data unrecoverable.

To date, a number of methods have been disclosed for rendering data stored on a solid state memory device unreadable. One such method teaches the erasing of the entire storage media. It is noted that certain solid state memory devices such as a NAND flash memory devices cannot be erased in one operation, and thus this method is often implemented by having the memory controller sequentially erase individual data blocks. Unfortunately, this operation can take a long time to complete, especially if the disk is a high capacity device. Furthermore, during the course of the operation an ‘erase failure’ event might occur, causing one or more specific memory blocks to remain accessible even after the attempted erasing.

Alternatively, sensitive data may be rendered unreadable through the effecting of several write and erase cycles, a process known as the “sanitizing” of the storage media. According to this technique, sensitive data is overwritten by some data pattern prior to the erasure of the blocks. In the event of an erase failure, data that was previously stored on overwritten storage blocks is still rendered inaccessible due to the extra step of overwriting the storage block. Unfortunately, this extra step of overwriting concomitantly slows the overall processing of sanitizing. A discussion of methods of sanitizing data storage devices is available in U.S. patent application Ser. No. 10/449,066 entitled “Methods of sanitizing a flash based data storage device” filed in Jun. 6, 2003 and incorporated herein by reference in its entirety.

In order to accelerate the process whereby data is rendered inaccessible, it is possible to delete only the disk controller firmware. Although this technique provides for the disabling of the disk interface itself, the sensitive data remains stored within intact components of the solid-state memory media, and can be accessed after soldering out the memory components and mounting these memory components in another system.

Another technique for rendering data stored on solid state memory devices inaccessible is to encrypt the contents of the memory device. Although this does provide some degree of protection, it is still possible for a hostile party with physical access to the encrypted data to crack the encryption.

There is an ongoing need for fast and effective apparatus and methods for rendering data residing on magnetic storage media and solid state memory devices such as flash memory devices unreadable. Unfortunately, all known methods of expunging data residing on solid state memory devices either have an intolerably high failure rate or are too slow for many relevant applications.

### SUMMARY OF THE INVENTION

The aforementioned needs are satisfied by several aspects of the present invention.

It is now disclosed for the first time a memory device including at least one memory component and a damaging mechanism for damaging at least one memory component of the device. In some embodiments, the memory device provides one or more explicit commands for activating the damaging mechanism, and the damaging mechanism is operative to damage the memory component in accordance with one or more commands. Exemplary commands include but are not limited to software commands, hardware signals, electrical signals and combinations thereof. Any known mechanism or combination of mechanisms for damaging memory components is appropriate for the present invention. In some embodiments, the damaging mechanism is operative to effect the damaging by subjecting at least a portion of the memory component to an electrical perturbation that is sufficient to damage the memory component. Exemplary sufficient electric perturbations include but are not limited to sufficient electrical current and sufficient electrical voltage, each of which are applied for a sufficiently long time in order to damage the solid state memory component.

Not wishing to be bound by any particular theory, it is noted that the presence of an extreme current within or in proximity of a memory die generates an extreme heat for physically burning at least a portion of a memory die. Nevertheless, it is noted that any mechanism for generating the heat and/or burning the die is appropriate. In another example, the damaging mechanism includes a caustic chemical to which at least a portion of the memory component is exposed upon activation of the damaging mechanism. Alternately or additionally, the damaging mechanism includes a mechanical and/or magnetic mechanism for destroying the memory component.

There are numerous scenarios where it is useful and even necessary to quickly and reliably expunge data from a solid state memory device by damaging one or more memory components. In one example, sensitive data resides on a disk drive mounted on a military aircraft forced to land in hostile territory, and it is necessary to sacrifice the actual memory device by hastily damaging one or more components of the device in order to render this data inaccessible. In another example, a flash memory device with sensitive corporate data is pilfered by a competitor who proceeds to attempt to access data. Upon detection of the unauthorized access attempt, the controller on the device activates the mechanism for damaging memory components.

According to some embodiments, the presently disclosed memory device is a non-volatile memory device including non-volatile memory components such as mechanical hard drives with magnetic media and flash memory device having NAND flash memory components.

Certain solid state memory components such as NAND flash components provide a plurality of pins including but not limited to input pints, output pins, input/output pins and power supply pins for the normal operation of the device. Nonetheless, it is noted that an extreme voltage applied by the damaging mechanism to one or more of these aforementioned pins can also be useful for damaging the device and thus, according to some embodiments, the damaging mechanism is operative to apply sufficient voltage to at least one pin. It is also noted that any pin of the memory component may be an appropriate location for applying the sufficient voltage for damaging the component including the GND pin to which zero voltage is usually applied during the normal operation of the memory device.

According to some embodiments, the damaging mechanism is operative to damage all memory components of the memory device. Alternatively, the damaging mechanism is operative to damage only some memory components.

Thus, according to some embodiments, the memory device supports a plurality of commands, wherein according to a first command all memory components of the solid state memory device are damaged, while according to a second command only some memory components of the solid state memory device are damaged.

Optionally, the presently disclosed device provides one or more mechanisms for reducing the probability that data residing on one or more memory components remains accessible after the damaging operation. Thus, in some embodiments, an erase and/or sanitize operation is executed prior to activation of the damaging mechanism, thereby rendering the component un-usable both on the data as well as the die level.

It is recognized sometimes it is necessary to verify that the memory component was indeed damaged, especially for situations where sensitive data resides on the device. In some embodiments, the device includes an optional damage assessing mechanism for assessing a damage status of a damaged memory component. In some embodiments, the damage assessing mechanism assesses the damage status by attempting to read known data from a purportedly damaged memory component. It some embodiments, the memory component is a flash medium such as a NAND flash component, and verification includes reading the ID code of the flash component.

Sometimes, it is desired to damage a plurality of memory components in a specific order. This is especially relevant for situations where it is known that more sensitive data resides on specific components. For example, if the solid state disk includes 128 memory components but only two of these components contain highly critical data, then it is preferred to first damage or disable the two components on which the more sensitive data resides, and only afterwards to damage some or all of the remaining memory components. Thus, according to some embodiments the memory device includes a prioritizing mechanism for prioritizing an order in which a plurality of solid state memory components is damaged.

In some embodiments, the order in which memory components are to be damaged is specified at the time of design of the memory device. Alternatively or additionally, the order is determined in part in accordance with specifications received at a latter time. In one specific embodiment, data specifying the order is provided to the device together with the explicit command to activate the damaging mechanism.

Certain embodiments provide mechanisms for reducing the probability of unintentional and/or unauthorized activation of the damaging device. Thus, in some embodiments, the damaging mechanism is operative to damage a memory component in accordance with one or more electrical signals, hardware signals and/or software commands. In one example, a voltage sufficient to damage a memory component may be gated by two serial switches. Each switch is controlled by a different controller in order to avoid a situation wherein a firmware flaw results in unintentional activation of the damaging mechanism.

Optionally, the damaging mechanism is operative to damage the memory component only upon user authentication. Preferably, the user authentication is performed from a host device to which the memory device is coupled. Alternatively or additionally, the memory device provides an authentication interface for user authentication.

According to some embodiments, the damaging mechanism is operative to damage a memory component of the device upon detection of a predetermined condition including but not limited to a logical condition such as an unauthorized attempt to access a memory component. Other appropriate logical conditions include but are not limited to a condition wherein a preselected datum stored in a memory component is accessed more than a predetermined number of times and a condition wherein a preselected portion of at least one memory component is accessed more than a predetermined number of times.

It is now disclosed for the first time a method of disabling a memory device having a plurality of memory components. The presently disclosed method includes the steps of including within the memory device a damaging mechanism for damaging at least one of the memory components, and effecting a damaging of one or more memory components using the damaging mechanism.

According to some embodiments, the damaging is effected by the damaging mechanism in accordance with a received command. Alternatively or additionally, the damaging is effected by the damaging mechanism in accordance with a detected physical and/or logical condition such as, for example, a detected time out event. Thus, certain embodiments of the present invention provide a damaging mechanism that is operative to damage one or more memory components even in the absence of a specific command to effect damaging.

According to some embodiments, the step of effecting damaging includes damaging all of the memory components.

According to some embodiments, the command is a command to damage all of the memory components.

According to some embodiments, the step of effecting damaging includes damaging only some of the memory components.

According to some embodiments, the command is a command to damage only some of the memory components.

According to some embodiments, the method further includes assessing a damage status of at least one of the memory components.

According to some embodiments, the step of assessing includes attempting to read data from at least one memory component.

According to some embodiments, the step of effecting damaging includes subjecting at least a portion of one of the memory components to a sufficient electrical perturbation to damage at least one memory component.

Appropriate electrical perturbations include but are not limited to a sufficient electrical current and a sufficient voltage.

According to some embodiments, the subjecting includes applying sufficient voltage to a pin of a memory component.

According to some embodiments, the pin is selected from the group consisting of an input pin, an output pin, an input/output pin, and a power supply pin.

According to some embodiments, the effecting damaging includes damaging a plurality of memory components in a specified order.

According to some embodiments, the command is sent only upon user authentication.

In some embodiments, the physical damaging of a memory component renders the component unusable and/or unreadable.

These and further embodiments will be apparent from the detailed description and examples that follow.

### BRIEF DESCRIPTION OF THE DRAWINGS

FIG. 1 provides a block diagram of an exemplary solid state memory device including a damaging mechanism for damaging one or more memory components.

FIG. 2A provides a block diagram of an exemplary solid state memory device including a damaging mechanism for damaging one or more memory components.

FIG. 2B provides a block diagram of an exemplary solid state memory device where a damaging mechanism is embedded partially or completely within a memory component.

FIG. 3 provides a flow chart of an exemplary firmware algorithm for damaging NAND flash memory components.

FIG. 4 provides a schematic diagram of a hardware implementation for disabling a NAND flash device.

FIG. 5 provides a schematic diagram of an apparatus for damaging a NAND flash component.

FIG. 6 provides an image of a NAND flash component damaged in an experiment carried out by the present inventor.

### DETAILED DESCRIPTION OF THE INVENTION

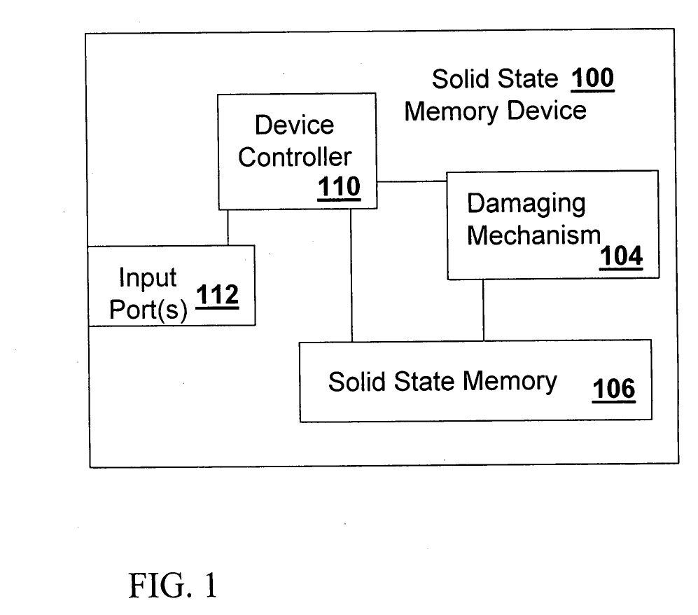

FIG. 1 provides a block diagram of an exemplary solid state memory device 100 including a damaging mechanism for damaging or one or more solid state memory components. The exemplary device 100 includes a device controller 110 which stores data received through one or more input ports 112 in non-volatile memory 106 such as a flash media or magnetic media. In different embodiments, the device control 110 is implemented as electronic circuitry, software, or a combination thereof. It is noted any electrical means that allows the device to receive a physical signal is considered an input port 112. Thus, the input port 112 can be as simple as a simple electrical wire. Exemplary input ports 112 include but are not limited to USB ports, ports for receiving a mechanical and/or optical signal such as PS2 ports, I/O ports, serial ports, ports connected with pins such as jumper pins, circuitry for receiving a signal from a push button, circuitry for receiving a wireless signal, parallel ports and smartcard ports such as ISO 7816 compatible interfaces. Although some ports are operative to receive electronic data, any electrical circuitry for receiving any physical or electronic signal is considered an input port 112.

Optionally, the solid state memory device 100 is a flash device that is used by host device (not shown) to store data in the solid state memory 106, and one of the input ports 112 is a communications port operative to communicate with the host device using a wired or wireless communication link.

Damaging Mechanism 104 is operative to damage one or more components of the solid state memory 106. In some embodiments, the damaging mechanism is operative to physically render one or more solid state memory components unusable on the device level.

Not wishing to be bound by any particular theory, it is noted that certain exemplary damaging mechanisms damage certain memory components such that it could be theoretically possible to physically recover some or all data residing on the die of the damaged solid state memory component, even if the solid state memory component is rendered unusable on the device level. This data recovery process could include constructing a new component, possibly including extracted physical media from the damaged memory component. Nevertheless, any damaging mechanism which temporarily or permanently renders a memory component unusable on the device level is within the scope of the present invention. In specific embodiments, the damaging mechanism is indeed operative to irreversibly expunge data residing within the memory component by physically damaging the component.

Any damaging mechanism, including but not limited to electrical damaging mechanisms, mechanical damaging mechanisms, chemical damaging mechanisms and magnetic damaging mechanisms is appropriate for the present invention. In some embodiments, the electrical damaging mechanism is operative to damage the memory component by applying an extreme voltage or extreme current to one or more locations within the memory component. Nonetheless, it is noted that “extreme voltage,” “extreme current,” “sufficient electrical perturbation to damage a memory component,” “sufficient electrical current to damage a memory component,” and “sufficient voltage to damage a memory component” are terms relative to the specific memory component being damaged, and what is “extreme” or “sufficient to damage” for one specific memory component or device is not necessarily “extreme” or “sufficient to damage” for another specific memory component or device.

In one specific example, the memory component to be damaged is specifically designed as such and subsequently embedded in a memory device that provides no specific mechanism for application of voltages and currents usually considered inappropriate for normal operation of the memory device. Thus, in this example the memory component provides specific locations where application of what is considered “normal” voltages or currents for device operation is nonetheless sufficient burn the memory die in that location and to thus damage the memory component. The design described in this example thus obviates the need to include within the device specific damaging mechanisms capable of producing electrical voltages or currents atypical for the device.

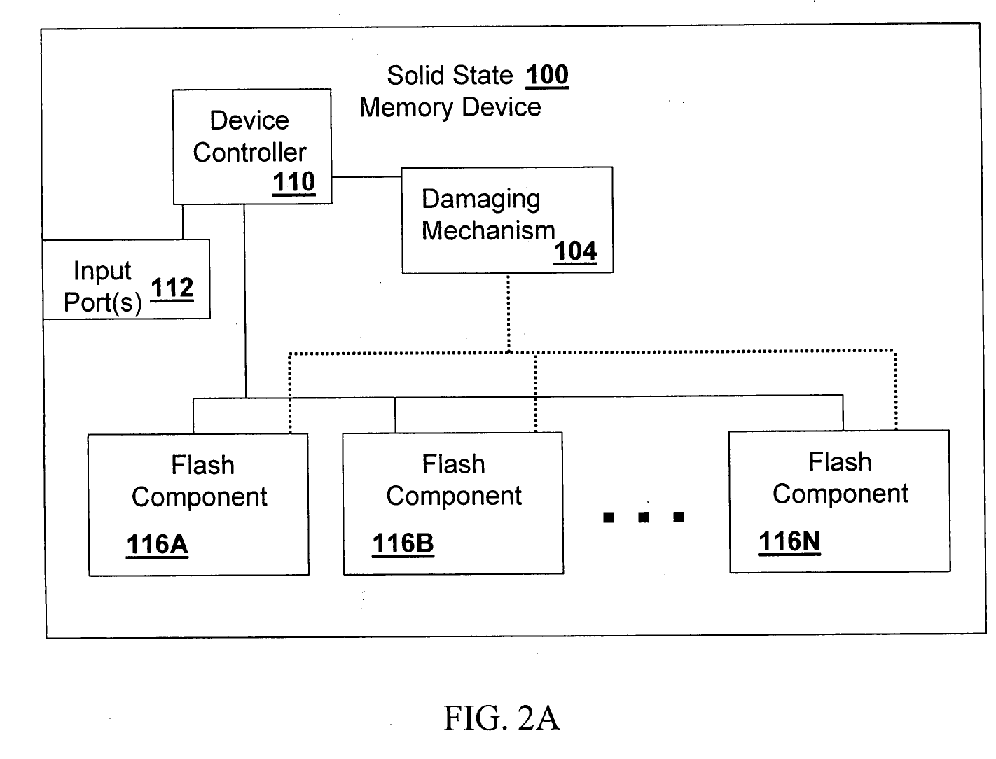

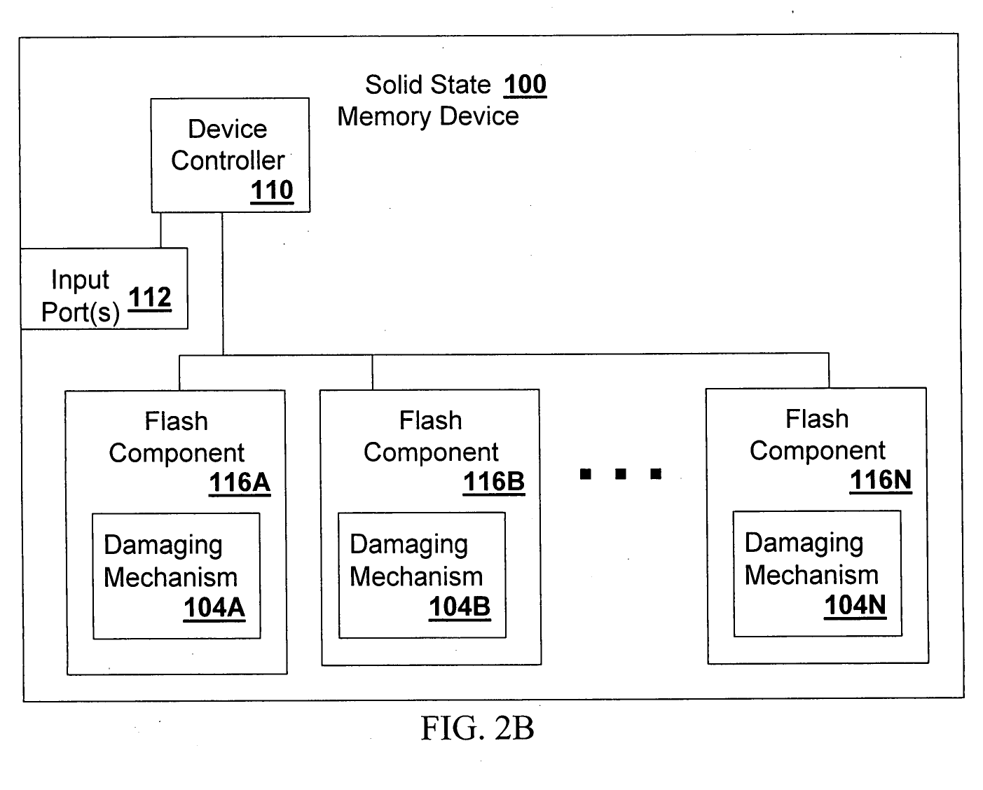

Furthermore, it is noted that in some embodiments of the present invention one or more damaging mechanisms are located partially or completely outside of the solid state memory component to be damaged, as illustrated in FIG. 2A.

Alternatively or additionally, a damaging mechanism is embedded partially or completely within a solid state memory component to be damaged, as illustrated in FIG. 2B. This obviates the need to include a damaging mechanism on the device level since the damaging feature is implemented within the specific memory component. In one particular example, the activation of the damaging mechanism is handled completely or partially by memory-component specific firmware residing within the memory component.

Optionally, the damaging mechanism 104 is operative to damage one or more memory components in accordance with one or more explicit commands including but not limited to a software command, a hardware signal, an electrical signal and any combination thereof.

According to some embodiments, a hardware signal is a physical event that transpires outside of the disk controller that is detected directly or indirectly by the disk controller. Exemplary hardware signals include but are not limited to voltage levels in a wire, a setting of a jumper (not shown), a status of a push button (not shown), and an incoming communication entering a communication port (not shown) such as an incoming RS-232 communication. Thus, in some embodiments, a change in the state of the hardware signal is detected and is operative to activate the damaging mechanism.

In some embodiments, the explicit command to activate the damaging mechanism 104 is received from the host device (not shown). In one particular embodiment, the command is a software command received from the host device (not shown).

Alternatively or additionally, the damaging mechanism is operative to effect damaging of memory components even in the absence of an explicit command. In one example, a specific physical and/or logical condition such as a loss of a connection to a host device or a time-out condition is detected. In some situations, a loss or unexpected loss of a connection to a host device is indicative of improper or hostile use of the memory device, and it is desirable to activate the damage mechanism to damage memory components on which sensitive data resides.

Optionally, the device provides a user interface for the damaging mechanism. One exemplary simple user interface is a mechanical interface such as a push button. Alternately or additionally, some embodiments provide for an electronic user interface or a visual interface such as an interface including an LCD display.

The principles of the present invention are applicable to any solid state memory device, including but not limited to flash memory devices and mechanical disk drives using magnetic storage media. In some embodiments, the flash memory device is embedded within a broader device, including but not limited to personal digital assistants, smart cards and cellular telephones, which provide additional functionality other than memory storage or features related to memory storage. According to certain embodiments of the present invention, these devices provide a damaging mechanism for damaging memory components.

The present inventor recognizes that there are certain circumstances wherein the owner of the memory device who wishes to destroy or damage one or more memory components of the device is, unfortunately, not always in physical possession of the device. Some embodiments provide for a wireless interface for activation of the damaging mechanism.

The following examples are to be considered merely as illustrative and non-limiting in nature. It will be apparent to one skilled in the art to which the present invention pertains that many modifications, permutations, and variations may be made without departing from the scope of the invention.

It is noted that example 1 describes a specific case wherein individual solid memory components are damaged sequentially. Although some embodiments of the present invention do indeed provide for sequential destruction of solid state memory components, this is not a limitation of the present invention. Alternatively, the present invention provides for the simultaneous or substantially simultaneous destruction of a plurality of memory components, or even for the simultaneous or substantially simultaneous destruction of all memory components of the solid state memory device.

### EXAMPLES

### Example 1

### A Firmware Example

One possible implementation of the present invention relates to NAND flash solid-state memory devices with dedicated hardware to damage the solid state memory components and dedicated firmware code within the disk's controller to control the damaging process.

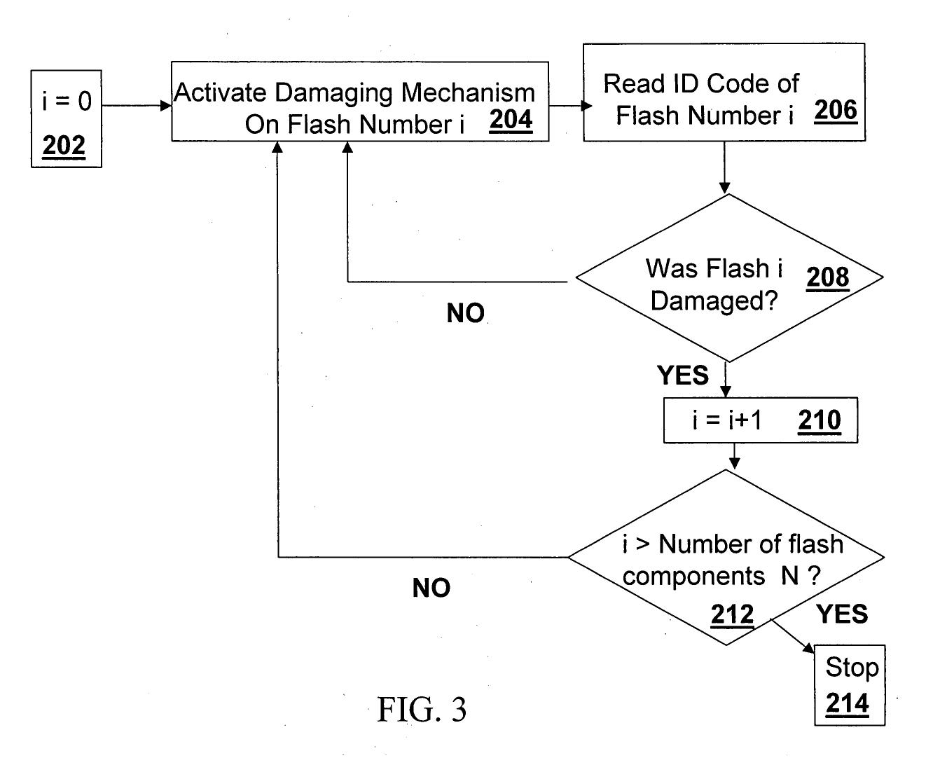

An exemplary firmware algorithm for destroying each NAND flash component within a flash device providing N flash components is described in the flowchart provided in FIG. 3.

The algorithm begins by setting the iterative variable i to 0 202, and then by activating the damaging mechanism on flash number i 204. In order to verify that individual NAND flash components were properly damaged, the ID code of each flash component is read 206. A successful ID code read is indicative that the damaging operation was unsuccessful. In the event that the flash was not damaged 208, an attempt is made again to activate 204 the damaging mechanism on flash number i. Otherwise, the current flash number variable i is iterated 201. If all flash components have been destroyed 212, the algorithm stops 214. If there are still flash components not appropriately damaged, the damaging mechanism is activated on the next flash component 204.

### Example 2

### Exemplary Hardware for Destroying NAND Components Within a Flash Device

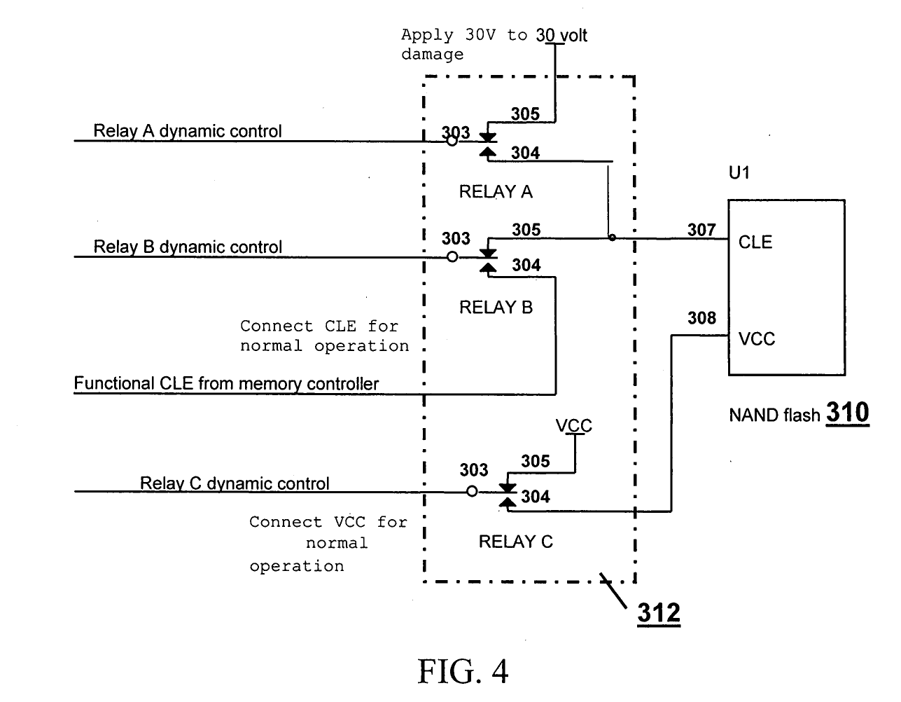

An exemplary hardware implementation of electronic circuitry operative to damage a single flash component 310 with CLE (command latch enable) 307 and VCC 308 input pins is provided in FIG. 4.

In order to disable normal access to the NAND flash component 310, a global necessary input may be damaged. The CLE input pin 307 of the NAND flash component 310 may be physically destroyed. Every read from the NAND flash component 310 must have a setup phase. CLE toggling is used in the setup phase. Damaging CLE functionality will thus result in an unusable NAND flash device on the component level.

High voltage (for example 28V) can be applied to a certain amount of time (for example 50 mSec) to the CLE pin 307. A set of switches such as relays 312 can protect the functional CLE buffer from unintentional damaging during normal operation. It is best to disconnect the NAND flash VCC input 308 in order to prevent high voltage from flowing back to the system power plane. A dynamic control over the switches will turn them to ‘on’ or ‘off’. Relay A provides the 30V to CLE input 307. Relay B provides functional CLE to CLE input. Relay C connects functional VCC to VCC input.

During the normal mode of operation, relay C is on applying functional VCC, relay B is on connecting functional CLE, and relay A is off disconnecting the 30V.

In the event that it is desired to damage or destroy NAND flash component 310, then relay C will be off disconnecting functional VCC, relay B will be off disconnecting functional CLE, and relay A will be on to apply the 30V.

### Example 3

### Experimental Results for an Exemplary NAND Flash Component

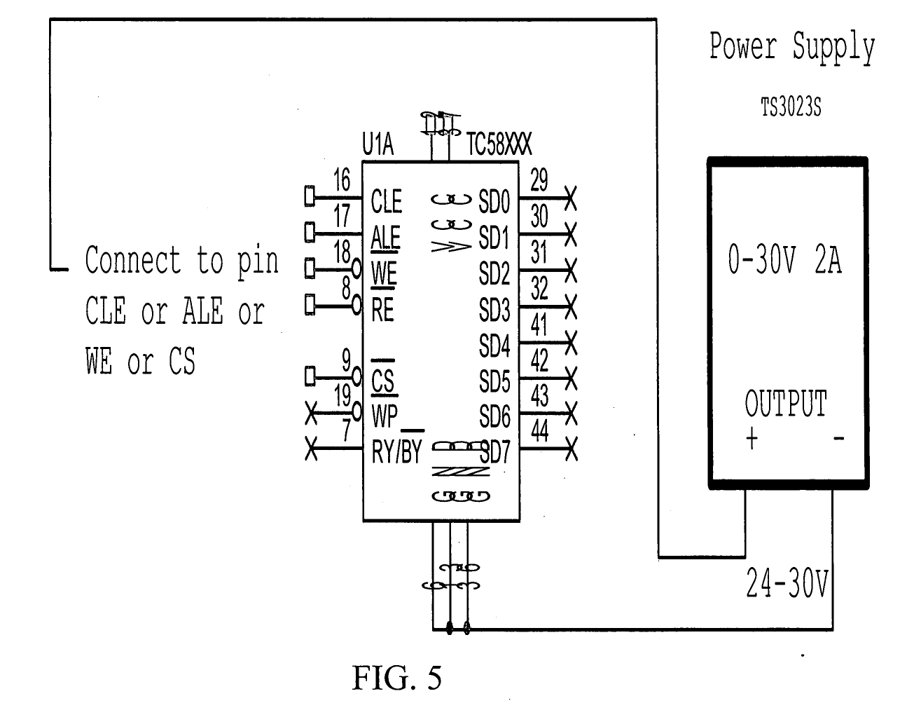

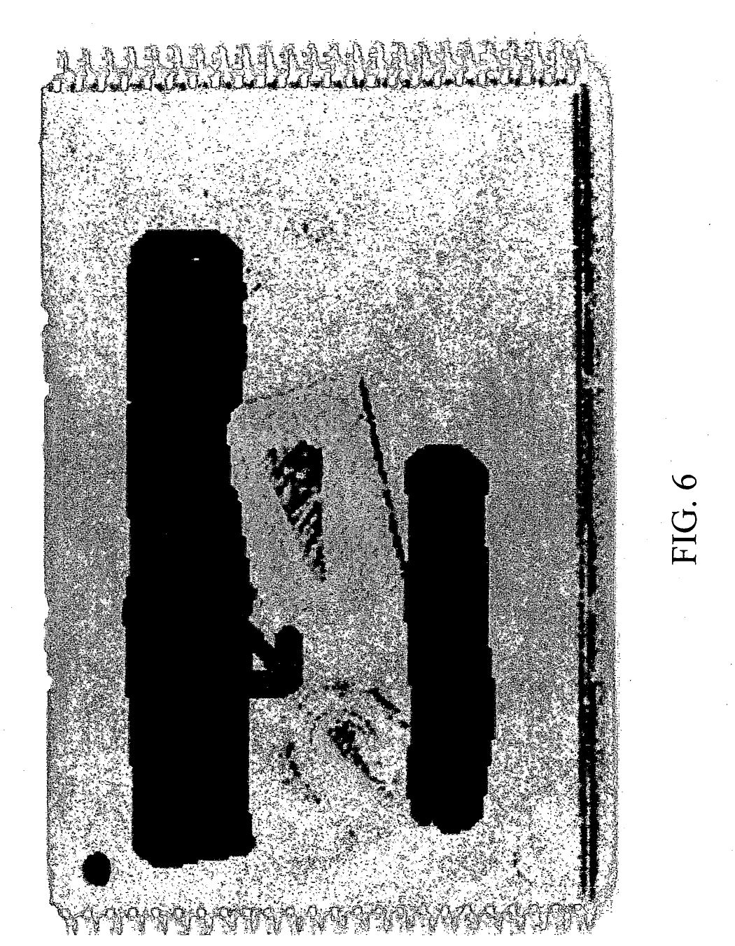

The present inventor has built an actual damaging device operative to damage a NAND flash component. Application of an electrical potential of about 30 volts to a CLE input of the NAND flash component resulted in rendering the flash component non-operational. FIG. 5 provides a schematic diagram of the damaging device built by the present inventor, and FIG. 6 provides an image of a NAND flash component damaged in the experiment.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

What is claimed is:

1) A memory device comprising:
a) at least one memory component;
b) a damaging mechanism for damaging a said memory component.

2) The memory device of claim 1 wherein the memory device comprises a plurality of said memory components and said mechanism is operative to damage all said memory components.

3) The memory device of claim 1 wherein the memory device comprises a plurality of said memory components and said mechanism is operative to damage only some said memory components.

4) The memory device of claim 1 wherein said damaging mechanism is operative to damage a said memory component in accordance with at least one command.

5) The memory device of claim 4 wherein according to a first said command all said memory components are damaged, and according to a second said command only some memory components are damaged.

6) The memory device of claim 4 wherein a said command is a software command.

7) The memory device of claim 4 wherein a said command is a hardware signal.

8) The memory device of claim 4 wherein a first said command is a software command, and a second said command is a hardware signal.

9) The memory device of claim 1 wherein a said memory component is non-volatile.

10) The memory device of claim 9 wherein a said non-volatile memory component is a NAND flash memory device.

11) The memory device of claim 1 wherein said damaging mechanism is operative to effect said damaging at least in part by subjecting at least a portion of said memory component to a sufficient electrical perturbation to damage said memory component.

12) The memory device of claim 11 wherein said electrical perturbation is selected from the group consisting of a sufficient electrical current and a sufficient voltage.

13) The memory device of claim 12 wherein a said memory component includes at least one pin, and said damaging mechanism is operative to apply said sufficient voltage to at least one said pin.

14) The memory device of claim 13 wherein a said pin is selected from the group consisting of an input pin, an output pin, an input/output pin, and a power supply pin.

15) The memory device of claim 1 further comprising:
c) a damage assessing mechanism for assessing a damage status of a said damaged memory component.

16) The memory device of claim 15 wherein said damage assessing mechanism effects said assessing by steps including attempting to read data from a said damaged memory component.

17) The memory device of claim 1 wherein the memory device comprises a plurality of said memory components further comprising:
c) a prioritizing mechanism for prioritizing an order in which a plurality of said solid state memory components are damaged by said damaging mechanism.

18) The memory device of claim 1 wherein said damaging mechanism is operative to damage a said memory component only upon user authentication.

19) The device of claim 1 wherein said damaging mechanism is operative to damage a said memory component upon detection of a predetermined condition.

20) The memory device of claim 19, wherein said condition is a logical condition.

21) The memory device of claim 20, wherein said logical condition is indicative of an attempted unauthorized access of said memory component.

22) The memory device of claim 20, wherein said logical condition is that a preselected datum stored in a said memory component is accessed more than a predetermined number of times.

23) The memory device of claim 20, wherein said logical condition is that a preselected portion of at least one memory component is accessed more than a predetermined number of times.

24) A method of disabling a memory device having a plurality of memory components, the method comprising:
a) including within the memory device a damaging mechanism for damaging at least one of the memory components;
b) using said damaging mechanism, effecting said damaging.

25) The method of claim 24 wherein said damaging is effected in accordance with a received command.

26) The method of claim 24 wherein said damaging is effected in accordance with a detected event.

27) The method of claim 24 wherein said step of effecting said damaging includes damaging all the memory components.

28) The method of claim 24 wherein command is a command to damage all the memory components.

29) The method of claim 24 wherein said step of effecting said damaging includes damaging only some of the memory components.

30) The method of claim 24 wherein command is a command to damage only some of the memory components.

31) The method of claim 24 further comprising:
c) assessing a damage status of at least one of the memory components.

32) The method of claim 31 wherein said step of assessing includes attempting to read data from said at least one memory component.

33) The method of claim 24 wherein said step of effecting said damaging includes subjecting at least a portion of one of the said memory components to a sufficient electrical perturbation to damage said one memory component.

34) The method of claim 33 wherein said electrical perturbation is selected from the group consisting of a sufficient electrical current and a sufficient voltage.

35) The method of claim 34 wherein said subjecting includes applying said sufficient voltage to a pin of a said memory component.

36) The method of claim 34 wherein said pin is selected from the group consisting of an input pin, an output pin, an input/output pin, and a power supply pin.

37) The method of claim 24 wherein a said command is a software command.

38) The method of claim 24 wherein a said command is a hardware signal.

39) The method of claim 24 wherein a first said command is a software command, and a second said command is a hardware signal.

40) The method of claim 24 wherein said effecting damaging includes damaging a plurality of memory components in a specified order.

41) The method of claim 24 wherein a said command is sent only upon user authentication.
